(19) United States
(12) Patent Application Publication
(10) Pub. No.: US 2003/0187087 A1
(43) Pub. Date: Oct. 2, 2003

(54) Two component coating composition and coating process using the same

(75) Inventors: Satoru Ihara, Saitama (JP); Katsuo Miyazaki, Saitama (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Honda Giken Kogyo Kabushiki Kaisha

(21) Appl. No.: 10/396,570

(22) Filed: Mar. 26, 2003

(30) Foreign Application Priority Data
Mar. 29, 2002 (JP) 2002-097478

(51) Int. Cl. B05D 3/02; C08G 2/00

(52) U.S. Cl. 522/168; 427/508; 427/385.5; 522/173

(57) ABSTRACT

A coating composition for top coating according to the present invention comprises a thermosetting component and a photo-curing component, which forms a film through a thermosetting and a following photo curing treatment. The thermosetting component and the photo-curing component in the coating composition is blended in such amounts sufficient for forming a film after the thermosetting treatment to have a prescribed repair property and for forming a final film after the photo curing treatment to have a prescribed wear resistance.

### BACKGROUND OF THE INVENTION

1. Field of the Invention

The present invention relates to a two-component coating composition comprising a thermosetting component and photo curing component, and a coating process using the same. More specifically, the invention relates to a coating composition in which repair operation can be conducted in a painting line such as an automobile painting line at the time of top-coating, and in which the film obtained after the final curing has sufficient wear resistance, and a coating process using such a coating composition.

2. Description of the Related Arts

In an exterior painting line such as for automobile, transparent paint excelling in wear resistance is top-coated onto a subject to be painted such as a metal plate having been surface-treated and primer-coated as a final finishing to form a clear coat.

Examples of paints, which have been used, include paint compositions for new cars comprising, for example, melamine/alkyd resins, thermosetting acrylic resins, or urethane resins and for cars to be repaired include nitrocellulose lacquers, modified acrylic lacquers, melamine/alkyd resin for baking at a low temperature, acrylic/melamine resins, quick-drying urethane resins and urethane resins.

In these conventional techniques, however, due to enhanced wear resistance of the film having been formed, the rigidity of the formed film becomes too high. This remains a problem in terms of the fact that repair operations conducted after the film formation of the exterior paint of automobile such as grinding of the film-defective portion and polishing for finishing can be carried out only with difficulty.

In the exterior painting line for automobile, the repair stage is a necessary stage in terms of quality for outward appearance, and if no repair stage is conducted, the production cannot be conducted in a practical manner.

Furthermore, if the rigidity of the final film is decreased in order to secure the repair ability, no practical wear resistance can be obtained.

Consequently, there is a demand for a coating composition for top coating, which can give a top coat having sufficient wear resistance and repair ability after coating, and for a coating process using the same.

### SUMMARY OF THE INVENTION

We have conducted research and investigation in light of the situation associated with the prior art. As a result, it has been discovered that by applying two-stage curing comprising a thermal curing treatment and a photo curing treatment, both rigidity enough for conducting repair during the course of the coating process and the final wear resistance can be obtained. Furthermore, we have discovered that in two-component system comprising a thermosetting component and a photo component, one component acts as a diluting component (filler) for the other component in which the former component weakens the performance of the other component. Consequently, it has been found that by blending both components within a level that the characteristics of both components can be satisfied; a two-component coating composition for top coating having the characteristics of both components can be produced.

The present invention has been made based on such a discovery.

According to the present invention, there is provided a coating composition for top coating comprising a thermosetting component and a photo-curing component, which forms a film through a thermosetting and a following photo curing treatment; said thermosetting component and said photo-curing component being blended in such amounts sufficient for forming a film after the thermosetting treatment to have a prescribed repair property and for forming a final film after the photo curing treatment to have a prescribed wear resistance.

A coating process according to the present invention is a process for top-coating a primer coated substance by two-stage curing consisting of a thermosetting treatment and a photo curing treatment. The process of the present invention comprises an application stage for applying the coating composition for top coating according to the present invention onto the primer-coated substance; a thermosetting stage for thermally treating the substance having said coating composition applied thereon at a temperature and for a period sufficient for thermosetting said thermosetting component to give a thermoset primary film; and a photo curing stage for irradiating a light for photo curing said photo curing component on said primary film to obtain a final film.

In the coating process of the present invention, the primary film obtained in said thermosetting stage may be inspected, and if the primary film is found to have a defective portion, the defective portion may be repaired.

### BRIEF DESCRIPTION OF THE DRAWING

FIG. 1 is a flowchart showing the coating process of the present invention.

### DESCRIPTION OF THE PREFERRED EMBODIMENTS

Embodiments of the present invention will now be described.

The terms used herein are defined as follows:

The term “prescribed repair property” intended herein means that a coat (primary film) formed after a thermosetting treatment can be repaired, typically by grinding or polishing for finish. Specifically, the primary film with the prescribed repair property is of softness sufficient for conducting repair such as grinding and polishing for finish.

The term “prescribed wear resistance” intended herein means that the final film formed after photo curing has sufficient wear resistance.

The term “curing” can be used in exchangeable with hardening, setting as used in this art.

The term “photo curing component” is intended to comprise a photo curing main agent (hereinafter referred to as “photo curing ingredient”) and a corresponding initiator.

[Coating Composition]

First, a coating composition (hereinafter referred to as “the composition of the present invention”) according to a first aspect of the present invention will now be described.

The composition of the present invention is composed of (a) a thermosetting component; (b) a photo curing component, and may contain any other component known in the art, such as a diluent.

As two-component type composition comprising a thermosetting composition and a photo curing composition, WO98/00456, which is incorporated herein by reference, discloses a specific polymerizing resin including a thermosetting functional group and a polymerizing group. However, the composition disclosed therein is intended to improve rigidity and resistance to injury, and there is no disclosure for the repair property intended in the present invention.

(Thermosetting Component)

In the present invention, any of thermosetting resins known per se, including, but not being restricted to, urethane, thermosetting aminoalkyd and thermosetting acrylic resins, may be used as the thermosetting composition. In the thermosetting component used according to the present invention, which forms a film upon a thermal treatment at a prescribed temperature, the resulting film should have a sufficient repair property. Specifically, the thermosetting component should be incorporated in such an amount that the film formed after the thermosetting treatment and before the photo curing treatment has sufficient repair property.

As one measurement for the repair property, pencil hardness of the film can be mentioned. According to a preferred embodiment of the present invention, the pencil hardness of the film obtained by thermosetting is not less than 6B, preferably from B to H. The pencil hardness bellow 6B is not preferable in terms of workability, i.e., the film is of poor adhesion to the substance to be coated. Conversely, if the film has pencil hardness greater than H makes, it can be repaired only with difficulty.

(Photo Curing Component)

The photo curing component intended herein is a component which is cured by the irradiation of a light with a prescribed wavelength, and comprises a photo-polymerizing oligomer [main polymerizing agent (photo curing ingredient) including a monomer in a broadest meaning), a reactive diluent, and a photoinitiator as main ingredients, and optionally comprising a reactive agent, an additive, and a colorant. The photo curing component can be classified into two types depending upon the reaction mechanisms. One type of the photo curing component is cured by a radical polymerization reaction. Another is cured by a cathion polymerization.

The radical polymerization types include, but are not restricted to, resins or oligomers containing acryloyl group and/or vinyl group as a functional group. The cathion polymerization types include, but are not restricted to, resins or oligomers containing epoxy group and/or vinyl ether group as a functional group.

Also, depending upon the kinds of the photo polymerizing oligomer (photo curing ingredient), the photo curing component can be roughly divided into (1) urethane/acrylate components; (2) epoxy/acrylate components; (3) ester/acrylate components; (4) acrylate components; (5) epoxy components; (6) vinyl ether component; and (7) oxethane components. Types (1) to (4) are components which are cured through a radical polymerization reaction, and types (5) to 7 are cured through a cathion polymerization reaction.

In the present invention, any of photo curing components suitably selected from these components can be used.

The purpose of adding this component is that the film having been cured by the thermosetting is further hardened to a prescribed hardness. Consequently, this component is incorporated in such an amount that the resulting final film has prescribed wear resistance.

Photo initiator making up the photo curing component is a polymerization initiator corresponding to the kind of the photo curing component (main agent) selected. Typical radical polymerization initiators include azo compounds and typical cathion polymerization initiators includes iodide salts and sulfonium salts.

(Solvent)

The solvents, which may be used in the present invention, are not specifically restricted as long as they can dissolve both curing components to be a specific viscosity.

(Optional Components)

Any of known additives can be added to the component of the present invention as long as they impair the effects and functions of the present invention.

(Reactivity of Two Components)

In the present invention, care should be taken to the reactivity of two components, particularly, the deterioration of the photo curing component at the time of thermosetting the coating composition of the present invention. Specifically, it is required to set conditions where the photo curing component is not deteriorated at the time of the coating composition of the present invention is thermoset. These conditions can be determined by previous experiments (see Examples, which will be described later on).

(Substance)

Substances to be coated (substrate) applicable to the coating composition of the present invention are not specifically restricted, as long as they are not modified under the coating conditions of the present invention (i.e., the thermosetting treatment and photo curing treatment). In particular, the coating composition of the present invention can be applied to an automobile part. Typical examples of the substances to be coated include, but are not restricted to, metal plates such as various steel plates, aluminum (alloy) plates, magnesium (alloy) plates; and heat resistant plastics.

In a preferred embodiment of the present invention, the substance to be treated is an automobile part. In the automobile part, the film requires a repair property during the course of painting process, and the final film also requires a prescribed wear resistance which can withstand repeatedly car washing. In the present invention, when the coating is applied to an automobile part, parts for new car and parts, which requires recoating due to accident or such are included in the automobile parts.

[Coating Process]

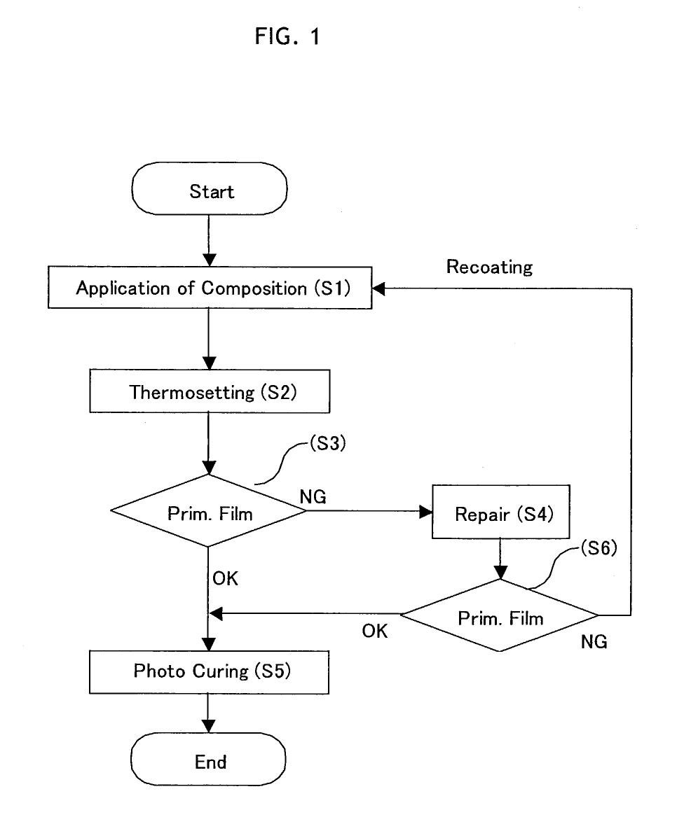

Next, the coating process of the present invention will now be described by referring to FIG. 1. FIG. 1 is a flowchart showing the coating process of the present invention.

In the present invention, the coating composition of the present invention is applied to a substance to be coated so as to be a prescribed thickness (S1).

The application of the coating composition may be carried out by any of the methods known in the art including, but being not restricted to, spray coating, roll coating, gravure coating, and knife coating.

Subsequently, the substance on which a prescribed thickness of the coating composition has been applied is thermally treated in a heater heated at a prescribed temperature to thermally cure the thermosetting component contained in the coating composition of the present invention (primary curing) (S2). The heater, which is used in this stage, is selected from among those well known in the art such as an oven, and an infrared heater.

The thermal treatment conditions are suitably selected depending upon the thermosetting component used in the coating composition. Preferred thermal treatment conditions are those where the photo curing component contained in the coating composition are not deteriorated.

The thermosetting of the thermosetting component contained in the coating composition of the present invention as described above provides a primary film formed on the surface of the substrate. The primary film is in the state where it is adhered on the substance in a sufficient manner and the photo curing component contained in the primary film still remains uncured.

In the next stage, the surface of thermoset film is inspected (S3). If abnormality such as adhesion of dust, lacking of film (the partial peeling off of the film etc.), uneven coating or the like is not found (OK), the stage is shifted to stage S5 to conduct a photo curing treatment. If any abnormality such as adhesion of dust is found in S3 (NG), the stage is shifted to stage S4, which is a stage for conducting a repair operation. After the repair operation, the repaired primary film coated on the substrate is again inspected in stage S6. In S6, if no abnormality is found (OK), then the stage is shifted to stage S5. If abnormality is found (NG), the stage is shifted to S1 to carry out recoating (Recoat: S1).

In repair stage S4 according to the present invention, the primary film obtained in the thermosetting stage, which still contains the functional groups of the thermosetting component, is adhered on the substance in a sufficient manner, and repair such as removal of dust can be conducted.

On the other hand, if no abnormality is found in S3 (OK) a photo curing treatment is carried out in S5. In this case, the substance having the primary film formed thereon in which no abnormality has been found in S3 may be stored, for example, in a dark portion, and the photo curing stage is conducted after a prescribed period. Alternatively, the photo curing can be continuously conducted, just after stage S3.

A light source for photo curing in the photo curing stage of the present invention is not restricted as long as it irradiates a light having a wavelength for initiating the photo curing of the photo curing component contained in the coating composition of the present invention such as ultraviolet lamps, and excimer laser.

As described above, by the photo curing treatment, the primary film which still contains functional groups and whose rigidity is insufficient can be hardened to a prescribed rigidity.

### EXAMPLES

The present invention will be described by the working examples and comparative examples. However, it should be noted that the present invention is not restricted to the working examples.

### Example and Comparative Examples

(Formulation of Coating Composition)

A coating composition of the present invention (Sample No. 2) and comparative composition (Nos. 1, 2, and 3) were formulated using amounts of the components shown in Table 1. As the photo initiator, Dull Cure #1173 from Specialty Chemicals Inc. was used.

TABLE 1
Unit: Parts by Weight

| | No. 1 | No. 2 | No. 3 |
|---|---|---|---|
| Thermosetting | 100 | 75 | 0 |
| Component* | | | |
| Photo Curing | 0 | 25 | 100 |
| Component** | | | |

*Orga #100-2 Clear (form Nippon Paint Co., Ltd.)
**Beam Set #575 (from Arakawa Chemicals)

(Curing Treatments)

Each of the coating compositions formulated as described above was coated on a soft steel plate (which had been treated with phosphoric acid, electrodeposited, surface of which had been coated with Orga P-5 (Nippon Paint Co., Ltd.,) followed by dried at 140° C. for 30 minutes). The soft steel plate was thermally treated (at 140° C. for 30 minutes) and/or photo-cured (irradiation of ultraviolet using a high-pressure mercury lamp (80 W/cm) at an irradiation distance of 10 cm at a treating rate of 3 m/minute) to form a film.

(Polishing Test)

A polishing test shown below was conducted for the resulting films in order to evaluate a repair property.

The films obtained by the curing treatment(s) was polished, with abrasion paper (#2000 water abrasion paper from 3M Corp.), then polished with very fine compound (hard 1 from 3M Corp.) for 45 minutes, and the coated surface was washed with water. Subsequently, the polished film was further polished with finishing compound (GX-II form Sankyo Rikagaku Corp.) for 45 minutes, and the coated surface was then washed with water.

The coated surface having been polished as described above was visibly evaluated as four-point evaluation where criterion 1 means that no scar is found, criterion 2 means that shallow scars remain, criterion 3 means that deep scars remains, and criterion 4 means that scars do not disappear. The tolerable level in this test is criteria 1 and 2. The results are shown in Table 2.

Evaluation for Abrasion Through Car Washing)

Subsequently, in order to evaluate wear resistance, the evaluation for abrasion through car washing was conducted as follows:

(1) An aqueous solution each containing 20 parts by weight of three types of test powders defined according to JIS Z 8901 was thoroughly mixed, and was applied on the coated surface in an amount of 100 ml per 1 m², followed by drying.

(2) Subsequently, the coated surface having the dust adhered thereon was placed in an automatic car washer, and the automatic car washer was rotated 40 times.

(3) After operations (1) and (2) were carried out twice, the four-point evaluation was visibly made in which criterion 1 means that noticeable washing scars cannot be found, criterion 2 means that slight washing scars can be found, criterion 3 means that noticeable washing scars can be found, and criterion 4 means that remarkably noticeable washing scars can be found. The tolerable level in this test is criteria 1 and 2. The results are shown in Table 2.

TABLE 2
Curing Treatments and Test Results

| Test No. | A | B | C | D |
|---|---|---|---|---|
| Sample No. | 1 | 2 | 2 | 3 |
| Thermosetting | Yes | Yes | Yes | No |
| Photo Curing | No | No | No | Yes |
| Polishing Test | 1 | 2 | 4 | 4 |
| Evaluation for Car | 3 | 3 | 2 | 1 |
| Washing | | | | |
| Note | | Primary Film | Final Film | |

It can be understood from FIG. 2 that in the case where the coating composition of the present invention (Sample No. 2) was used to only conduct the thermosetting treatment (Test No. B: Primary Film), the primary film formed has well repair property. Also, it has been proven that when the primary film was further subjected to photo curing treatment (Test No. C: Final Film), the final film obtained has sufficient wear resistance.

In contrast, in the case where only the thermosetting treatment is carried out (Test No. A), the resultant film has well repair ability, but has insufficient wear resistance. Also, in the case where only the photo curing treatment was conducted (Test No. D), the resultant film has sufficient wear resistance but has poor repair ability.

Consequently, it can be concluded that the film having both good repair property and good wear resistance can be obtained for the first time by two-stage curing treatment comprising the thermosetting treatment and the photo curing treatment.

What is claimed is:

1. A coating composition for top coating comprising a thermosetting component and a photo-curing component, which forms a film through a thermosetting treatment and a following photo curing treatment; said thermosetting component and a photo curing component being blended in such amounts sufficient for forming a film after said thermosetting treatment to have a prescribed repair property and for forming a final film after said photo curing treatment to have a prescribed wear resistance.

2. The coating process as claimed in claim 1, wherein said thermosetting component is selected from urethane, thermosetting aminoalkyd or thermosetting acrylic resins.

3. The coating process as claimed in claim 1, wherein said photo curing component comprises a photo curing specie selected from among an urethane/acrylate component, an epoxy/acrylate component, an ester/acrylate component, an acrylate component, an epoxy component, a vinyl ether component, or an oxethane component; and an initiator.

4. A coating process for top-coating a primer coated substance by two-stage curing consisting of a thermosetting treatment and a photo curing treatment, which comprises:
an application stage for applying the coating composition for top coating comprising a thermosetting component and a photo-curing component, which forms a film through thermosetting and the following photo-curing; said thermosetting component and a photo-curing component being blended in such amounts sufficient for forming a film after thermosetting to have a prescribed repair property and for forming a final film after photo-curing to have a prescribed wear resistance onto the primer-coated substance;
a thermosetting stage for thermally treating the substance having said coating composition applied thereon at a temperature and for a period sufficient for thermosetting said thermosetting component to give a thermoset primary film; and
a photo curing stage for irradiating a light for photo curing said photo curing component on said primary film to obtain a final film.

5. The coating process as claimed in claim 4, wherein said primary is formed so that the pencil hardness thereof becomes from 6B to H.

6. The coating process as claimed in claim 4, wherein the primary film obtained in said thermosetting stage is inspected, and if the primary film is found to have a defective portion, the defective portion is repaired.

7. The coating process as claimed in claim 5, wherein the primary film obtained in said thermosetting stage is inspected, and if the primary film is found to have a defective portion, the defective portion is repaired.

8. The coating process as claimed in any one of claims 5 to 7, wherein said substance is an automobile part.
